(19) United States
(12) Patent Application Publication
(10) Pub. No.: US 2005/0097274 A1
(43) Pub. Date: May 5, 2005

(54) Storage system and its access control method

(75) Inventor: Hiroyuki Ohtani, Tokyo (JP)

Correspondence Address: FOLEY AND LARDNER;SUITE 500, 3000 K STREET NW, WASHINGTON, DC, 20007, US

(73) Assignee: NEC CORPORATION

(21) Appl. No.: 10/960,722

(22) Filed: Oct. 8, 2004

(30) Foreign Application Priority Data
Oct. 29, 2003 (JP) 2003-369668

(51) Int. Cl. G06F 12/00; G06F 12/08

(52) U.S. Cl. 711/114; 711/170; 711/203

(57) ABSTRACT

A storage system configuring a logical storage device by dividing an area on a physical storage space formed by a group of several physical storage devices by the unit of physical block having a certain block length and by assigning the physical storage space in every physical block, comprises a logical storage control table which records identification information indicating whether a physical block is assigned to data or operation is bound to data created from a predetermined data arrangement pattern in every area on the logical storage device, and a data writing unit which, upon receipt of a request of writing data into an area of the logical storage device, when a data arrangement pattern of the writing request agrees with a previously-registered data arrangement pattern, records the identification information of the same data arrangement pattern into the logical storage control table correspondingly to the writing-requested area and abandons the writing request data.

### BACKGROUNDS OF THE INVENTION

b 1. Field of the Invention

The present invention relates to a storage system configuring a logical storage device by dividing the area on a physical storage space formed by a group of several physical storage devices by the unit of physical block having a certain block length and by assigning the physical storage space in every physical block, and more particularly to a storage system and its access control method for improving efficiency of assignment of physical storage devices.

2. Description of the Related Art

Heretofore, there has been such a storage system as forming a logical storage device by a group of several physical storage devices, like a disk array device represented by RAID (Redundant Arrays of Inexpensive/Independent Disks). Data to be stored in the logical storage device on this storage system will be dispersed and stored in each storage area on several physical storage devices.

Holding a table for bringing each logical storage area of a logical storage device into correspondence with each physical storage area of a physical storage device, a storage system controls the correspondence of the store data arrangement. In order to maintain high availability, it makes the store data redundant and then records the data into each physical storage device.

This storage system having such redundancy has such a problem that volume required by each physical storage device is increased according as store data is increased in size, also accompanied by increase in cost.

One example of the conventional technique to solve the cost increase in a storage system is disclosed in Japanese Patent Laid-Open (Kokai) No. Heisei 8-221875 (Article 1). This Article 1 discloses a technique for restraining the required physical storage capacity with storage areas of different redundancy prepared on a data storing system and by switching the storage areas of various redundancy selectively according to performance and reliability a user requires.

Further, Japanese Patent Laid-Open (Kokai) No. 2003-29935 (Article 2) discloses a technique in which when RAID is formed by physical storage devices of different physical storage capacity, an area of a physical storage device is effectively utilized with means of assigning a logical address to an unused area on the physical storage device, caused by difference in capacity.

Further, there is a method for separating configuration of a logical storage device and assignment of area on a physical storage device corresponding to the logical storage device and for assigning a storage area to a physical storage device corresponding to the logical storage device on demand according to a data writing request. According to this method, an actual area on a physical storage device is not necessary until a data writing request requires it, hence to save a useless area that remains unused and to realize a storage system which makes assignment of storage area efficient.

The above-mentioned conventional techniques, however, have the following problems.

The conventional storage system has a problem of hindering efficient assignment of physical storage devices because there necessarily exists some physical storage device for storing write data with respect to an area on a logical storage device.

That is because the conventional storage system, upon receipt of a data writing request from a host computer, records the data in a storage area on a predetermined physical storage device or records the data in a storage area assigned on demand, which requires the physical storage devices so many depending on the data writing requests from a host computer. Though some kind of program running on the host computer (file system, volume control program, backup recovery program, etc.) writes data of specified data storage format (arrangement pattern of data) into a storage system, the conventional storage system cannot cope with the processing depending on the data storage format (arrangement pattern of data) and it always assigns the area on a physical storage device with respect to the area relative to a writing request.

Therefore, introduction of the processing depending on data storage format (arrangement pattern of data) enables assignment of physical storage devices to be more efficient.

### SUMMARY OF THE INVENTION

In order to solve the above conventional problem, an object of the invention is to provide a storage system, forming a logical storage device by a group of several physical storage devices, and its access control method in which the assignment efficiency of physical storage devices can be improved and the cost can be decreased.

According to the first aspect of the invention, a storage system configuring a logical storage device by dividing an area on a physical storage space formed by a group of several physical storage devices by the unit of physical block having a certain block length and by assigning the physical storage space in every physical block, comprising
a logical storage control table which records identification information indicating whether the physical block is assigned to data or operation is bound to data created from a predetermined data arrangement pattern in every area on the logical storage device, and a data writing unit which, upon receipt of a request of writing data into an area of the logical storage device, when a data arrangement pattern of the writing request agrees with a previously-registered data arrangement pattern, records the identification information of the same data arrangement pattern into the logical storage control table correspondingly to the writing-requested area and abandons the writing request data.

According to the invention, as far as the writing request data as for a storage system follows the data arrangement pattern, assignment of an area on a physical storage device is not necessary, hence to improve the assignment efficiency of a physical storage device and decrease the cost of the storage system.

In the preferred construction, the storage system comprises a block releasing unit which releases the assigned physical block when the physical block has been already assigned to the area of the logical storage device.

In another preferred construction, when a data arrangement pattern of the writing request data does not agree with a previously-registered data arrangement pattern, the data writing unit assigns the physical block, records the identification information of the physical block into the logical storage control table correspondingly to the writing-requested area, and writes the writing request data into the physical block.

In another preferred construction, the storage system comprises a block releasing unit which releases the assigned physical block when the physical block has been already assigned to the area of the logical storage device, wherein when a data arrangement pattern of the writing request data does not agree with a previously-registered data arrangement pattern, the data writing unit assigns the physical block to the above data, records the identification information of the physical block into the logical storage control table correspondingly to the writing-requested area, and writes the writing request data into the physical block.

In another preferred construction, the storage system comprises a data arrangement pattern record table in which the identification information for uniquely identifying the data arrangement pattern and the respective corresponding data arrangement patterns are registered, wherein referring to the data arrangement pattern record table, whether or not there is a data arrangement pattern which agrees with the data arrangement pattern of the writing request data is judged.

In another preferred construction, the storage system comprises a data arrangement pattern analyzing unit which checks the data arrangement pattern record table and returns the identification information of a data arrangement pattern to the data writing unit when the specified data agrees with the data arrangement pattern on the data arrangement pattern record table.

In another preferred construction, the storage system comprises a physical storage control table which records each set of identification information for identifying the physical block, address on the physical storage space corresponding to the physical block, and an assignment flag indicating whether the physical block has been already assigned as an area of the logical storage device, and a block assigning unit which obtains an assignable physical block from the physical storage control table, assigns the corresponding physical block to the specified area on the logical storage device, and records the identification information of the corresponding physical block into the logical storage control table.

In another preferred construction, the storage system comprises a data reading unit which, upon receipt of a request of reading data from the area of the logical storage device, with reference to the logical storage control table, when a physical block has been already assigned to the area on the logical storage device from which data is read out, reads the data from the physical block, and when identification information of the data arrangement pattern is recorded for the above-area, creates data from the data arrangement pattern corresponding to the identification information, and returns the created data.

In another preferred construction, the storage system comprises a data arrangement pattern setting unit which sets each identification information of data arrangement patterns and arbitrary data arrangement patterns to the data arrangement pattern record table.

According to another aspect of the invention, an access control method of a storage system configuring a logical storage device by dividing an area on a physical storage space formed by a group of several physical storage devices by the unit of physical block having a certain block length and by assigning the physical storage space in every physical block, comprising
a step of having a logical storage control table which records identification information indicating whether the physical block is assigned to data or operation is bound to data created from a predetermined data arrangement pattern in every area on the logical storage device, and a step of, upon receipt of a request of writing data into an area of the logical storage device, when a data arrangement pattern of the writing request agrees with a previously-registered data arrangement pattern, recording the identification information of the same data arrangement pattern into the logical storage control table correspondingly to the writing-requested area and abandoning the writing request data.

According to another aspect of the invention, an access control program for controlling access of a storage system configuring a logical storage device by dividing an area on a physical storage space formed by a group of several physical storage devices by the unit of physical block having a certain block length and by assigning the physical storage space in every physical block, comprising
a function of having a logical storage control table which records identification information indicating whether the physical block is assigned to data or operation is bound to data created from a predetermined data arrangement pattern in every area on the logical storage device, and a function of, upon receipt of a request of writing data into an area of the logical storage device, when a data arrangement pattern of the writing request agrees with a previously-registered data arrangement pattern, recording the identification information of the same data arrangement pattern into the logical storage control table correspondingly to the writing-requested area and abandoning the writing request data.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a block diagram showing the structure of a storage system according to a preferred embodiment of the invention;

FIG. 2 is a view showing an example of a physical storage control table in the embodiment of FIG. 1;

FIG. 3 is a view showing an example of a record table of data arrangement pattern in the embodiment of FIG. 1;

FIG. 4 is a view showing an example of a logical storage control table in the embodiment of FIG. 1;

FIG. 5 is a flow chart showing the operation of a data writing unit in the embodiment;

FIG. 6 is a flow chart showing the operation of a data arrangement pattern analyzing unit in the embodiment;

FIG. 7 is a flow chart showing the operation of a block assigning unit in the embodiment;

FIG. 8 is a flow chart showing the operation of a block releasing unit in the embodiment; and

FIG. 9 is a flow chart showing the operation of a data reading unit in the embodiment.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

Hereinafter, a preferred embodiment of the invention will be described with reference to the drawings.

### Structure of the Embodiment

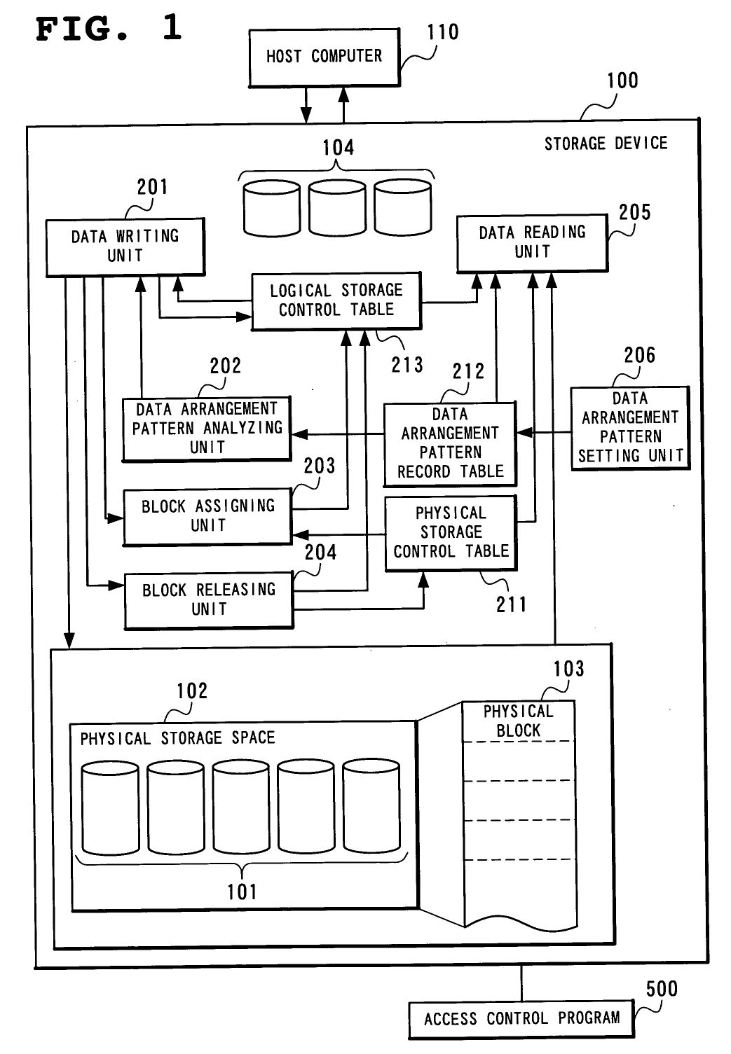

FIG. 1 is a block diagram showing the structure of a storage system according to a preferred embodiment of the invention.

A storage system 100 of the embodiment comprises a physical storage space 102, a logical storage device 104, a physical storage control table 211, a data arrangement pattern record table 212, a logical storage control table 213, a data writing unit 201, a data arrangement pattern analyzing unit 202, a block assigning unit 203, a block releasing unit 204, a data reading unit 205, and a data arrangement pattern setting unit 206.

The physical storage space 102 consists of a group of one and more physical storage devices 101 which form a virtual physical storage space. The area on the physical storage space 102 is divided into a plurality of physical blocks 103 of certain length.

The logical storage device 104 is a logical storage on the storage system 100 formed by a group of the physical blocks 103 on the physical storage space 102. The logical storage device is formed by assigning the physical storage space in every physical block.

The storage system 100 is connected to a host computer 110 which issues a data writing request or a data reading request to the logical storage device 104.

The physical storage control table 211 is a table for controlling the assignment state of the physical blocks 103.

The data arrangement pattern record table 212 is a table for recording each pair of identification information of data arrangement condition and the corresponding data arrangement condition.

The logical storage control table 213 is a table for recording each correspondence between a logical storage space forming the logical storage device 104 and the physical blocks 103 on the physical storage space 102.

The data writing unit 201 has a function of writing data in the logical storage device 104 on the storage system 100 upon receipt of a writing request from the host computer 110.

The data arrangement pattern analyzing unit 202 has a function of analyzing a data arrangement pattern of the data written into the logical storage device 104.

The block assigning unit 203 has a function of assigning each physical block 103 for storing data into the logical storage space on the logical storage device 104.

The block releasing unit 204 has a function of releasing the physical block 103 which has been already assigned to a logical storage device 104.

The data reading unit 205 has a function of reading data from the logical storage device 104, upon receipt of a reading request from the host computer 110.

The data arrangement pattern setting unit 206 sets some data arrangement condition in the data arrangement pattern record table 212.

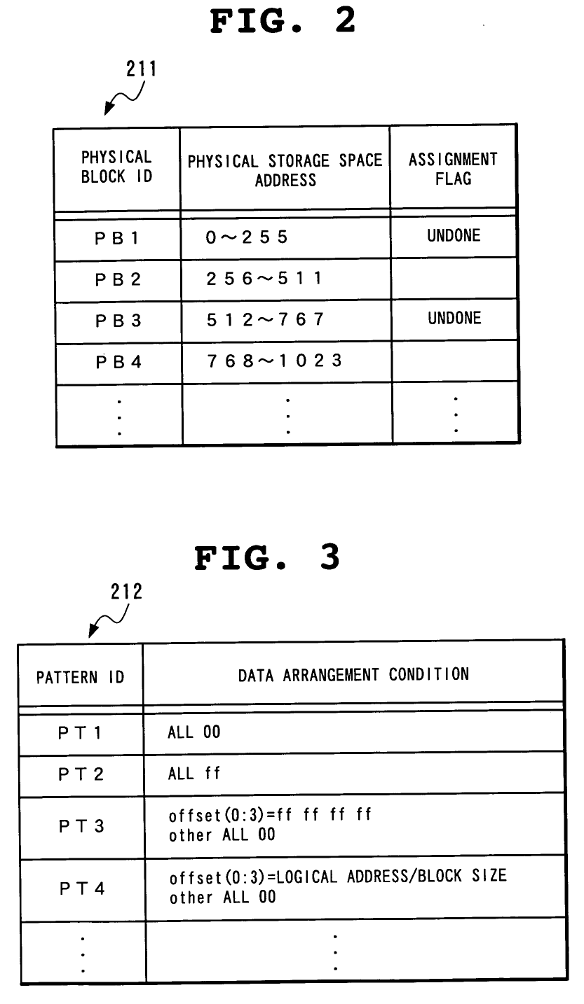

FIG. 2 is a view showing an example of the physical storage control table 211. The physical storage control table 211 records each correspondence of physical block ID that is the information for identifying a physical block 103, physical storage space address indicating an address on the physical storage space 102 corresponding to the physical block, and an assignment flag indicating whether the physical block has been already assigned as the area forming a logical storage device 104.

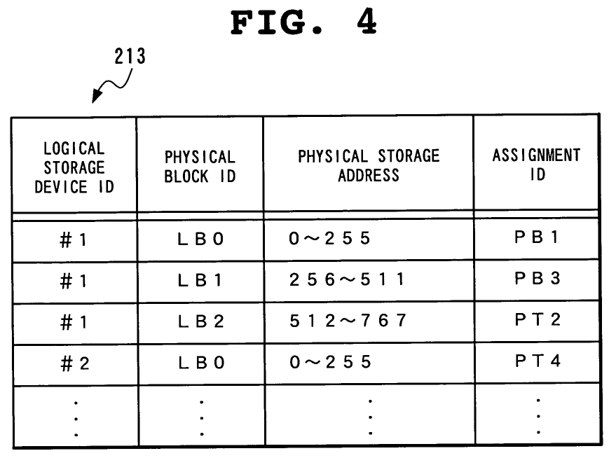

FIG. 3 is a view showing an example of the data arrangement pattern record table 212. The data arrangement pattern record table 212 records each correspondence of pattern ID that is the information for identifying a data arrangement condition and data arrangement condition indicated by the pattern ID.

Here, the data arrangement condition may include a concrete constant or a variable parameter depending on a request such as offset address. For example, the data arrangement condition of the pattern ID “PT1” indicates that the area on the target block is satisfied by “00h”. The data arrangement condition of the pattern ID “PT4” indicates that the 0 to 3 bytes at the head take a value obtained by dividing the logical storage address on the logical storage device 104 by the block size and that the remaining block areas are all satisfied by “00h”.

As mentioned above, the data arrangement pattern record table 212 is to keep each data arrangement condition suitable for each arrangement pattern of data (data storing format) written according to a program running on the host computer 110 using the logical storage device 104.

Namely, in a program (file system, volume control program, backup recover program, etc.) running on the host computer 110 using the storage system 100, when it is found that a data arrangement pattern following a specified condition is to be stored in a logical storage device 104 on the storage system 100, the condition of the data arrangement pattern is stored in the data arrangement pattern record table 212 of the storage system 100.

The data arrangement pattern setting unit 206 provides the data arrangement pattern record table 212 with a function of recording each pattern ID of identifying a unique data arrangement condition and the respective corresponding data arrangement condition. It is preferable that a user of the logical storage device 104 previously set the data arrangement conditions by using the data arrangement pattern setting unit 206. Alternatively, another pattern ID and data arrangement condition may be added afterward.

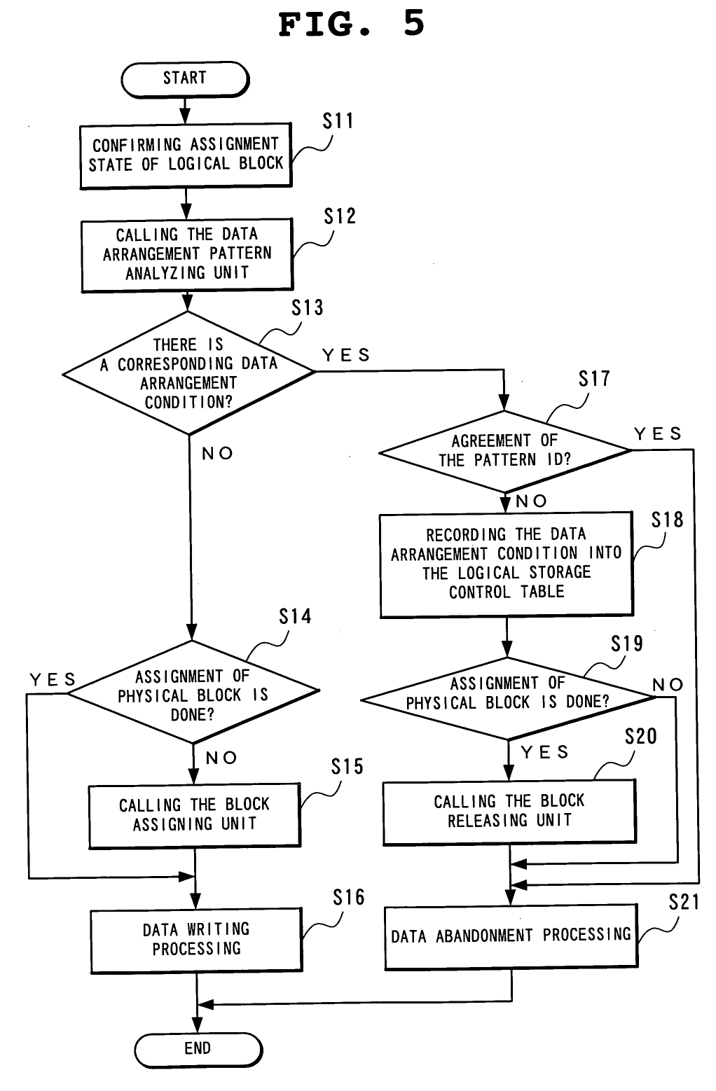

FIG. 4 is a view showing an example of the logical storage control table 213. The logical storage control table 213 records each correspondence of logical storage device ID that is the information for identifying a logical storage device 104, logical block ID for identifying each block obtained by dividing the area on one logical storage device 104 by the block unit, logical storage address indicating an address of the area on the logical storage device 104 corresponding to the logical block, and assignment ID for indicating whether the physical block 103 has been assigned to the logical block or it should follow the data arrangement pattern.

In the assignment ID, one of physical block ID and pattern ID is recorded. When some physical block ID is recorded in the assignment ID, it shows that the physical block is assigned to the area on the logical storage device 104 and that data is recorded in the physical storage device 101 corresponding to the physical block. While, when some pattern ID is recorded in the assignment ID, it shows that the area on the logical storage device 104 follows the data created from the data arrangement condition corresponding to the pattern ID.

(Description of the Operation)

The detailed operation of the embodiment constituted as mentioned above will be described with reference to the drawings.

FIG. 5 is a flow chart showing the operation of the data writing unit 201 of the storage system 100.

The data writing unit 201 starts the operation upon receipt of a data writing request from the host computer 110.

Receiving a data writing request, the data writing unit 201 checks the logical storage device ID corresponding to the logical storage device 104 concerned with the writing request, the logical storage address, and which area the data writing request is targeted for on the logical storage device 104 based on the data size and obtains an entry of the logical storage control table 213 corresponding to the writing request and the logical block ID indicated by the entry with reference to the logical storage control table 213 (Step S11).

Then, it specifies the writing data and calls the data arrangement pattern analyzing unit 202, hence to compare the writing data with data arrangement conditions of the data arrangement pattern record table 212 and check whether there is a corresponding data arrangement condition. When there is, it obtains the pattern ID of the corresponding data arrangement condition (Step S12).

As a result of the comparison in Step S12, when there is not any data arrangement condition corresponding to the writing data, it is judged that the data arrangement condition of the writing data is not registered yet in the storage system 100, so that some physical area for recording the writing data is necessary (Step S13), and the operation moves to Step S14.

While, there is a corresponding data arrangement condition, it is judged that the data arrangement condition of the writing data has been already registered in the storage system 100, so that a physical area for registering the writing data is not necessary (Step S13), and the operation moves to Step S17.

In Step S13, when there is no data arrangement condition of the writing data and the assignment ID in the entry of the logical storage control table 213 having been required in Step S11 means physical block ID, it is judged that a physical block 103 has been already assigned to the logical block. While, when the assignment ID means pattern ID, it is judged that a physical block 103 is not assigned to the logical block yet (Step S14).

In Step S14, when it is judged that any physical block 103 is not assigned there yet, the block assigning unit 203 is called through specification of the logical storage device ID and the logical block ID, to assign a physical block 103 corresponding to the physical storage space 102 for storing the writing data in the area on the logical storage device 104 (Step S15).

Finally, the writing requested data is written in the physical block 103 (Step S16).

On the other hand, when there is a data arrangement condition of the writing data in Step S13, when the assignment ID of the entry of the logical storage control table 213 required in Step S11 means pattern ID and the pattern ID agrees with the pattern ID of the data arrangement condition required in the data arrangement pattern analyzing unit 202 in Step S12, it is judged that the pattern ID corresponding to the writing data has been already recorded in the logical storage control table 213, so that update of the logical storage control table is not necessary (Step S17).

When the assignment ID of the entry of the logical storage control table 213 means physical block ID or when the assignment ID of the entry means pattern ID but does not agree with the pattern ID of the data arrangement condition required in Step S12, it is judged that update of the logical storage control table 213 is necessary (Step S17).

When it is judged that update of the logical storage control table 213 is necessary in Step S17, the assignment ID of the entry on the logical storage control table 213 is read out and stored as the past assignment ID, and then the pattern ID corresponding to the data arrangement condition of the writing data is recorded on the assignment ID of the entry, hence to update the logical storage control table 213 (Step S18).

When the past assignment ID stored in Step S18 means physical block ID, it is judged that a physical block 103 has been already assigned to the logical storage area corresponding to the writing request. While, when the past assignment ID means pattern ID, it is judged that any physical block 103 is not assigned yet (Step S19).

When it is judged that a physical block 103 has been already assigned there in Step S19, the past assignment ID being stored is specified as a physical block ID to be released, to call the block releasing unit 204, hence to release the physical block (step S20).

After completing the processing of Step S20, or when the pattern ID corresponding to the writing data has been already recorded in the logical storage control table 213 in Step S17, or when any physical block 103 is not yet assigned to the logical storage area corresponding to the writing request in Step S19, the writing requested data is abandoned, hence to complete the processing (Step S21).

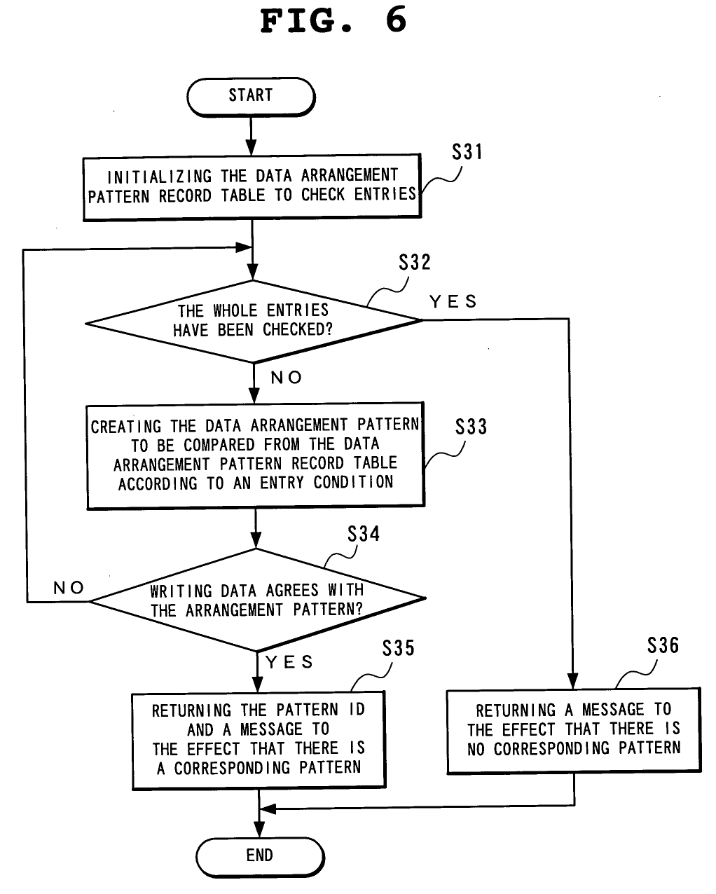

FIG. 6 is a flow chart showing the detailed operation of the data arrangement pattern analyzing unit 202 in Step S12 of FIG. 5. The data arrangement pattern analyzing unit 202 is activated upon a call from the data writing unit 201 with designation of data to be checked.

The data arrangement pattern analyzing unit 202 initializes the data arrangement pattern record table 212 in order to check the whole entries thereof (Step S31).

It checks whether every entry of the data arrangement pattern record table 212 has been checked or not and when there is some entry remaining unchecked, it continues to check (Step S32).

It obtains a data arrangement condition recorded in the next entry in the data arrangement pattern record table 212, to interpret the data arrangement condition and create a data arrangement pattern to be compared (Step S33).

It compares the above data arrangement pattern which has been created in Step S33 with the specified data to be checked (writing data) and in the case of no agreement, the operation is returned to Step S32, where the next entry is checked (Step S34).

When the data arrangement pattern created in Step S33 agrees with the above data to be checked (writing data), it returns to the data writing unit 201 of the calling party a message to the effect that there is a corresponding pattern condition, together with the pattern ID (Step S35).

While, when the whole entries have been checked in Step S32, it returns to the data writing unit 201 of the calling party a message to the effect that there is no pattern corresponding to the data to be checked (writing data) (S36).

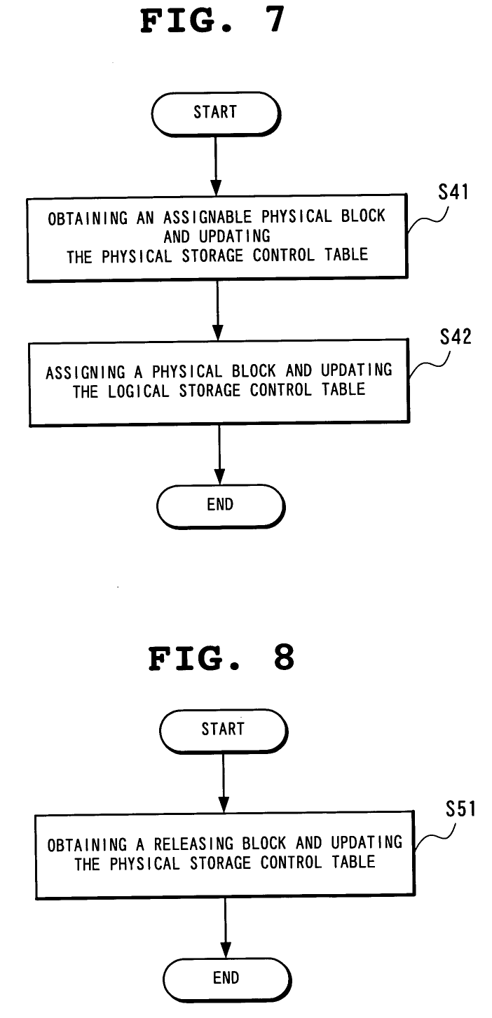

FIG. 7 is a flow chart showing the detailed operation of the block assigning unit 203 in Step S15 of FIG. 5. The block assigning unit 203 is activated upon a call from the data writing unit 201 with designation of the logical storage device ID and the logical block ID.

The block assigning unit 203 refers to the physical storage control table 211 and selects a physical block 103 which is not assigned to the logical storage device 104 according to the state of assignment flag. The physical block 103 is to be reserved for assignment at this point, and therefore, assignment is done is recorded in this assignment flag of the physical storage control table 211 and the physical storage control table 211 is updated (Step S41).

Next, it selects the specified logical storage device ID and an entry corresponding to the logical block ID from the logical storage control-table 213, records the physical block ID for identifying the physical block 103 selected in Step S41 into the assignment ID corresponding to the entry, and updates the logical storage control table 213 (Step S42).

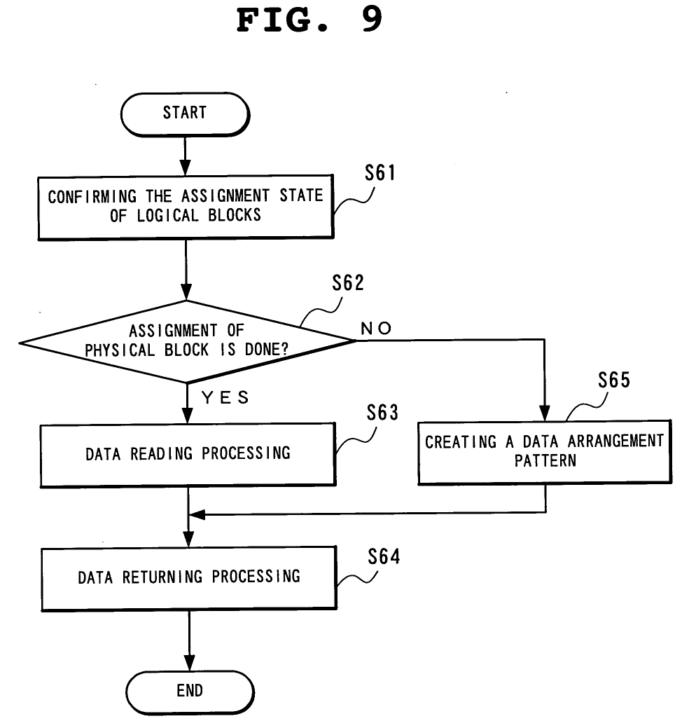

FIG. 8 is a flow chart showing the detailed operation of the block releasing unit 204 in Step S20 of FIG. 5. The block releasing unit 204 is activated upon a call from the data writing unit 201 with designation of the physical ID.

The block releasing unit 204 selects an entry corresponding to the physical block ID specified from the physical storage control table 211, records that the assignment of the physical block is undone in the assignment flag of the selected entry, and updates the physical storage control table 211 (Step S51).

As mentioned above, upon receipt of a data writing request from the host computer 110, the data writing unit 201 checks whether there is a data arrangement condition on the data arrangement pattern record table 212, which agrees with the writing data, and when there is no such condition, it assigns a physical block 103 to the area on the logical storage device 104 which has received the data writing request and writes the requested data there.

While, when there is such a data arrangement condition, it records into the logical storage control table 213 to the effect that the area on the logical storage device 104 which has received the request follows the data arrangement condition, and abandons the requested data without assignment of a physical block 103. When a physical block 103 has been already assigned to the area, the assigned physical block 103 is released.

Thus, as far as data to be written in the storage system 100 follows a data arrangement condition, assignment of a physical block, an area on the physical storage device 101, becomes unnecessary, thereby to improve assignment efficiency of physical storage devices and to decrease the cost of a storage system.

FIG. 9 is a flow chart showing the operation of the data reading unit 205 of the storage system 100.

The data reading unit 205 is activated upon receipt of a data reading request from the host computer 110.

Upon receipt of a data reading request, the data reading unit 205 judges logical storage device ID corresponding to the logical storage device 104 from which data is requested to be read out, logical storage address, and which area the data writing request is targeted for on the logical storage device 104 based on the data size, obtains an entry of the logical storage control table 213 corresponding to the data reading request with reference to the logical storage control table 213 and gets a logical block ID and an assignment ID indicated by the entry (Step S61).

When the assignment ID of the entry in the logical storage control table 213 means physical block ID, it is judged that a physical block 103 has been already assigned. While, when the assignment ID means pattern ID, it is judged that a physical block 103 is not yet assigned (Step S62).

When a physical block 103 has been already assigned, in Step S62, it reads out the requested data (Step S63) from an offset address of the physical storage space 102 indicated by the physical block ID, with reference to the physical storage control table 211.

Finally, it returns the read out data to the host computer 110 which accepted the data reading request (Step S64).

On the other hand, when it is judged that a physical block 103 is not yet assigned, in Step S62, it obtains a data arrangement condition indicated by the pattern ID recorded in the assignment ID of the entry with reference to the data arrangement pattern record table 212 and creates data according to the data arrangement condition (Step S65). Thereafter, in Step S64, it returns the created data to the host computer 110 which accepted the data reading request.

As mentioned above, upon receipt of a data reading request from the host computer 110, when a physical block 103 has been already assigned to the area on the logical storage device 104 corresponding to the data reading request, with reference to the logical storage control table 213, the data reading unit 205 reads out the data from the corresponding physical block 103 and returns the read out data to the host computer 110.

While, when a storage area on the logical storage device 104 concerned with the request follows a data arrangement condition on the data arrangement pattern record table 212, it creates data according to the data arrangement condition and returns the created data to the host computer 110.

Although the above embodiment is provided with the data arrangement pattern setting unit 206 for recording each pattern ID for uniquely identifying a data arrangement condition and the respective corresponding data arrangement conditions into the data arrangement pattern record table 212, it is not restricted to this structure but it is not always necessary to provide with the data arrangement pattern setting unit 206.

Even when the data arrangement pattern record table 212 does not have a new data arrangement condition added ex post facto but has a specified data arrangement condition predetermined (for example, data arrangement condition of only two patterns in which data to be written is all “00h” or all “FFh”), it is possible to improve assignment efficiency of the physical storage devices 101 and decrease the required cost as far as writing data follows the data arrangement condition. However, expected effect of decreasing the cost is less than that of the above-mentioned embodiment.

It is needless to say that a function of the storage system of the invention may be realized by hard ware, and it can be realized by soft ware, according to an access control program (application) 500 running on a computer, which executes various functions of the above-mentioned components (data writing unit 201, data reading unit 205, data arrangement pattern analyzing unit 202, block assigning unit 203, block releasing unit 204). This access control program 500 is stored in a magnetic disk, a semiconductor memory, and the other storing medium and loaded from such storing medium to a computer, to control the operation of the computer, thereby to realize the above-mentioned various functions.

Although the invention has been described taking the preferred embodiment for instance, the invention is not restricted to the above but various modifications can be made within the scope and the sprit of the technique.

According to the storage system and the data access method of the invention, the following effects can be achieved.

In a program (file system, volume control program, back-up recover program, etc.) running on a host computer using the storage system, when it is found that a data arrangement pattern following a specified condition is to be written in a logical storage device on the storage system, the data arrangement pattern condition is recorded in the storage system, hence to record only the identification information of the data arrangement condition there as for a data writing request to a logical storage device, without assignment of an area on the physical storage device. Therefore, as far as the writing data into the storage system follows the data arrangement condition, assignment of an area on the physical storage device is not necessary, so that assignment efficiency of the physical storage devices can be extremely improved and the cost of the storage system can be decreased.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

1. A storage system configuring a logical storage device by dividing an area on a physical storage space formed by a group of several physical storage devices by the unit of physical block having a certain block length and by assigning the physical storage space in every physical block, comprising
a logical storage control table which records identification information indicating whether said physical block is assigned to data or operation is bound to data created from a predetermined data arrangement pattern in every area on said logical storage device, and
a data writing unit which, upon receipt of a request of writing data into an area of said logical storage device, when a data arrangement pattern of the writing request agrees with a previously-registered data arrangement pattern, records the identification information of the same data arrangement pattern into said logical storage control table correspondingly to the writing-requested area and abandons said writing request data.

2. The storage system as set forth in claim 1, comprising
a block releasing unit which releases the assigned physical block when said physical block has been already assigned to the area of said logical storage device.

3. The storage system as set forth in claim 1, in which
when a data arrangement pattern of said writing request data does not agree with a previously-registered data arrangement pattern, said data writing unit assigns said physical block, records the identification information of the physical block into said logical storage control table correspondingly to the writing-requested area, and writes said writing request data into said physical block.

4. The storage system as set forth in claim 1, comprising
a block releasing unit which releases the assigned physical block when said physical block has been already assigned to the area of said logical storage device, wherein
when a data arrangement pattern of said writing request data does not agree with a previously-registered data arrangement pattern, said data writing unit assigns said physical block to the above data, records the identification information of the physical block into said logical storage control table correspondingly to the writing-requested area, and writes said writing request data into said physical block.

5. The storage system as set forth in claim 1, comprising
a data arrangement pattern record table in which said identification information for uniquely identifying said data arrangement pattern and said respective corresponding data arrangement patterns are registered, wherein
referring to said data arrangement pattern record table, whether or not there is a data arrangement pattern which agrees with the data arrangement pattern of said writing request data is judged.

6. The storage system as set forth in claim 5, comprising
a data arrangement pattern analyzing unit which checks said data arrangement pattern record table and returns the identification information of a data arrangement pattern to said data writing unit when the specified data agrees with the data arrangement pattern on the data arrangement pattern record table.

7. The storage system as set forth in claim 1, comprising
a physical storage control table which records each set of identification information for identifying said physical block, address on the physical storage space corresponding to said physical block, and an assignment flag indicating whether said physical block has been already assigned as an area of said logical storage device, and
a block assigning unit which obtains an assignable physical block from said physical storage control table, assigns the corresponding physical block to the specified area on the logical storage device, and records the identification information of the corresponding physical block into said logical storage control table.

8. The storage system as set forth in claim 1, comprising
a data reading unit which, upon receipt of a request of reading data from the area of said logical storage device, with reference to said logical storage control table, when a physical block has been already assigned to the area on said logical storage device from which data is read out, reads the data from the physical block, and when identification information of said data arrangement pattern is recorded for the above area, creates data from the data arrangement pattern corresponding to said identification information, and returns the created data.

9. The storage system as set forth in claim 5, comprising
a data arrangement pattern setting unit which sets each identification information of data arrangement patterns and arbitrary data arrangement patterns to said data arrangement pattern record table.

10. An access control method of a storage system configuring a logical storage device by dividing an area on a physical storage space formed by a group of several physical storage devices by the unit of physical block having a certain block length and by assigning the physical storage space in every physical block, comprising
a step of having a logical storage control table which records identification information indicating whether said physical block is assigned to data or operation is bound to data created from a predetermined data arrangement pattern in every area on said logical storage device, and
a step of, upon receipt of a request of writing data into an area of said logical storage device, when a data arrangement pattern of the writing request agrees with a previously-registered data arrangement pattern, recording the identification information of the same data arrangement pattern into said logical storage control table correspondingly to the writing-requested area and abandoning said writing request data.

11. The access control method of the storage system as set forth in claim 10, comprising
a step of releasing the assigned physical block when said physical block has been already assigned to the area of said logical storage device.

12. The access control method of the storage system as set forth in claim 10, comprising
a step of, when a data arrangement pattern of said writing request data does not agree with a previously-registered data arrangement pattern, assigning said physical block, recording the identification information of the physical block into said logical storage control table correspondingly to the writing-requested area, and writing said writing request data into said physical block.

13. The access control method of the storage system as set forth in claim 10, comprising
a step of releasing the assigned physical block when said physical block has been already assigned to the area of said logical storage device, and
a step of, when a data arrangement pattern of said writing request data does not agree with a previously-registered data arrangement pattern, assigning said physical block to the above data, recording the identification information of the physical block into said logical storage control table correspondingly to the writing-requested area, and writing said writing request data into said physical block.

14. The access control method of the storage system as set forth in claim 10, comprising
a step of having a data arrangement pattern record table in which said identification information for uniquely identifying said data arrangement pattern and said respective corresponding data arrangement patterns are registered, and
a step of judging whether or not there is a data arrangement pattern which agrees with the data arrangement pattern of said writing request data, with reference to said data arrangement pattern record table.

15. The access control method of the storage system as set forth in claim 14, comprising
a step of checking said data arrangement pattern record table and returning the identification information of a data arrangement pattern when the specified data agrees with the data arrangement pattern on the data arrangement pattern record table.

16. The access control method of the storage system as set forth in claim 10, comprising
a step of having a physical storage control table which records each set of identification information for identifying said physical block, address on the physical storage space corresponding to said physical block, and an assignment flag indicating whether said physical block has been already assigned as an area of said logical storage device, and
a step of obtaining an assignable physical block from said physical storage control table, assigning the corresponding physical block to the specified area on the logical storage device, and recording the identification information of the corresponding physical block into said logical storage control table.

17. The access control method of the storage system as set forth in claim 10, comprising
a step of, upon receipt of a request of reading data from the area of said logical storage device, with reference to said logical storage control table, reading data from a physical block when the physical block has been already assigned to the area on said logical storage device from which the data is read out, and when identification information of said data arrangement pattern is recorded for the above area, creating data from the data arrangement pattern corresponding to said identification information, and returning the created data.

18. An access control program for controlling access of a storage system configuring a logical storage device by dividing an area on a physical storage space formed by a group of several physical storage devices by the unit of physical block having a certain block length and by assigning the physical storage space in every physical block, comprising
a function of having a logical storage control table which records identification information indicating whether said physical block is assigned to data or operation is bound to data created from a predetermined data arrangement pattern in every area on said logical storage device, and
a function of, upon receipt of a request of writing data into an area of said logical storage device, when a data arrangement pattern of the writing request agrees with a previously-registered data arrangement pattern, recording the identification information of the same data arrangement pattern into said logical storage control table correspondingly to the writing-requested area and abandoning said writing request data.

19. The access control program of the storage system as set forth in claim 18, comprising
a function of releasing the assigned physical block when said physical block has been already assigned to the area of said logical storage device.

20. The access control program of the storage system as set forth in claim 18, comprising
a function of, when a data arrangement pattern of said writing request data does not agree with a previously-registered data arrangement pattern, assigning a physical block, recording the identification information of the physical block into said logical storage control table correspondingly to the writing-requested area, and writing said writing request data into said physical block.

21. The access control program of the storage system as set forth in claim 18, comprising
a function of releasing the assigned physical block when said physical block has been already assigned to the area of said logical storage device, and
a function of, when a data arrangement pattern of said writing request data does not agree with a previously-registered data arrangement pattern, assigning said physical block to the above data, recording the identification information of the physical block into said logical storage control table correspondingly to the writing-requested area, and writing said writing request data into said physical block.

22. The access control program of the storage system as set forth in claim 18, comprising
a function of having a data arrangement pattern record table in which said identification information for uniquely identifying said data arrangement pattern and said respective corresponding data arrangement patterns are registered, and
a function of judging whether or not there is a data arrangement pattern which agrees with the data arrangement pattern of said writing request data, with reference to said data arrangement pattern record table.

23. The access control program of the storage system as set forth in claim 22, comprising
a function of checking said data arrangement pattern record table and returning the identification information of a data arrangement pattern when the specified data agrees with the data arrangement pattern on the data arrangement pattern record table.

24. The access control program of the storage system as set forth in claim 18, comprising
a function of having a physical storage control table which records each set of identification information for identifying said physical block, address on the physical storage space corresponding to said physical block, and an assignment flag indicating whether said physical block has been already assigned as an area of said logical storage device, and
a function of obtaining an assignable physical block from said physical storage control table, assigning the corresponding physical block to the specified area on the logical storage device, and recording the identification information of the corresponding physical block into said logical storage control table.

25. The access control program of the storage system as set forth in claim 18, comprising
a function of, upon receipt of a request of reading data from the area of said logical storage device, with reference to said logical storage control table, reading data from a physical block when the physical block has been already assigned to the area on said logical storage device from which the data is read out, and when identification information of said data arrangement pattern is recorded for the above area, creating data from the data arrangement pattern corresponding to said identification information, and returning the created data.
